(19) United States
(12) Patent Application Publication
(10) Pub. No.: US 2008/0111268 A1
(43) Pub. Date: May 15, 2008

(54) Method for making patterned products

(76) Inventor: Tien-Jen Lo, Kaoshiung (TW)

Correspondence Address: BRINKS HOFER GILSON & LIONE, P.O. BOX 10395, CHICAGO, IL, 60610, US

(21) Appl. No.: 11/598,809

(22) Filed: Nov. 13, 2006

(51) Int. Cl. B29C 43/20

(52) U.S. Cl. 264/77

(57) ABSTRACT

A method for making patterned products includes the steps of: a) providing a plurality of differently colored granular plastic materials in a predetermined ratio to prepare one batch of molding material; b) melting together the granular plastic materials in such a manner that different colors of the granular plastic materials are put together non-homogeneously; and c) molding the granular plastic materials that have been melted to form the patterned products. The patterned products formed from the one batch of the molding material are different in color and pattern.

### BACKGROUND OF THE INVENTION

1. Field of the Invention

The invention relates to a method for making patterned products, more particularly to a method for making patterned products having the appearance of imitation porcelain.

2. Description of the Related Art

Conventionally, patterned melamine housewares are made by adhering a patterned film on a semi-product of the melamine houseware and by applying a luster enhancing layer on the patterned film.

However, for the same batch of the housewares, each of the semi-products of the housewares is formed with the same single color, and the patterns formed on the same batch of the housewares are identical to each other. Furthermore, since the pattern on the housewares is formed by adhering the patterned film on the semi-product, it is liable to peel therefrom after a period of use.

### SUMMARY OF THE INVENTION

Therefore, the object of the present invention is to provide a method for making patterned products having the appearance of imitation porcelain without requiring adhering of a patterned film.

The method for making patterned products according to this invention includes the steps of: a) providing a plurality of differently colored granular plastic materials in a predetermined ratio to prepare one batch of molding material; b) melting together the granular plastic materials in such a manner that different colors of the granular plastic materials are put together non-homogeneously; and c) molding the granular plastic materials that have been melted to form the patterned products. The patterned products formed from the one batch of the molding material are different in color and pattern.

### BRIEF DESCRIPTION OF THE DRAWING

Other features and advantages of the present invention will become apparent in the following detailed description of the preferred embodiment with reference to the accompanying drawing, of which:

FIG. 1 is a flow diagram of the preferred embodiment of a method for making patterned products according to this invention.

### DETAILED DESCRIPTION OF THE PREFERRED EMBODIMENT

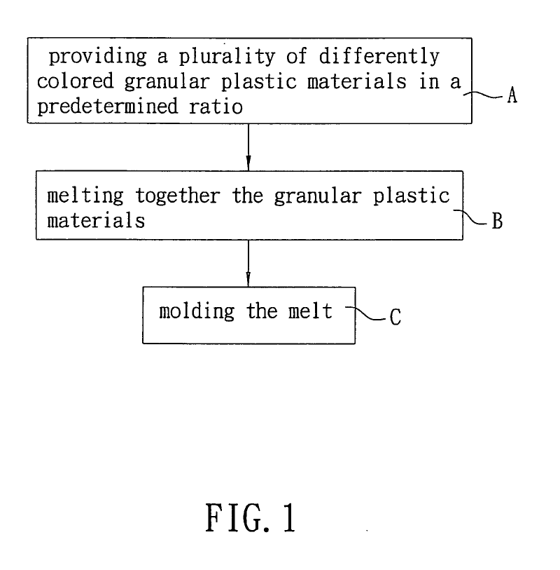

Referring to FIG. 1, the preferred embodiment of the method for making patterned products according to this invention includes the steps of:

A) providing a plurality of differently colored granular plastic materials in a predetermined ratio:

Each of the granular plastic materials is prepared by blending a resin with a coloring agent (such as red, blue, green or white coloring agent) and water to form a mixture and by forming the mixture into granules. Each coloring agent is used for making a mixture for forming the granules of each color. The resin used in the preferred embodiment is melamine. The weight ratio of the resin to the coloring agent ranges from 1:0.0001 to 1:0.001. The granules of each color are made by forming the mixture into a dough or a strip, which is then cut into the granules. The granules made thereby have a size ranging from 10 to 150 mm, and can have any suitable cross-sectional shape, such as circular shape, triangular shape, or square shape.

The granules are dried by baking at a temperature ranging from 80 to 120° C., preferably at 100° C. If the granules are dried at a temperature out of the preferred range, the hardness of the dried granules may be not suitable for the subsequent processing procedure. Preferably, the granules are further processed by ball milling so as to homogenize the size of the granules, and by sieving to classify the granules according to the sizes thereof.

The aforesaid processing procedures are repeated so as to make differently colored granular plastic materials.

A plurality of the differently colored granular plastic materials is then provided in a predetermined ratio to prepare one batch of molding material. The ratio is determined based on a specific color ratio of the pattern to be formed on the patterned products that are to be made. For example, if the patterns to be formed on the patterned products that are to be made are composed of about 70% blue color, about 20% red color, and about 10% white color, the batch of the molding material is composed of 70 wt % of blue granular plastic materials, 20 wt % of red granular plastic materials, and 10 wt % of white granular plastic materials.

B) melting together the granular plastic materials:

The batch of molding material formed by the differently colored granular plastic materials in the predetermined ratio is melted in such a manner that different colors of the granular plastic materials are put together non-homogeneously to form a melt. That is to say, the colors of the melt of the granular plastic materials are mixed non-homogeneously and form a variety of patterns throughout the melt.

C) molding the melt:

The granular plastic materials that have been melted are molded by any suitable manner, such as by compression molding, so as to form the patterned products.

In view of the aforesaid, since the pattern on each of the products is formed simultaneously when the products are molded, the film-peeling problem encountered in the prior art can be avoided. Furthermore, each of the products made by this invention has a unique imitation porcelain pattern different from that of the other patterned products, even when the same ratio of the differently colored granular plastic materials is maintained.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for making patterned products, comprising the steps of:
a) providing a plurality of differently colored granular plastic materials in a predetermined ratio to prepare one batch of molding material;
b) melting together the granular plastic materials in such a manner that different colors of the granular plastic materials are put together non-homogeneously; and
c) molding the granular plastic materials that have been melted to form the patterned products;
wherein the patterned products formed from the one batch of the molding material are different in color and pattern.

2. The method as claimed in claim 1, wherein each of the granular plastic materials is prepared by blending a resin with a coloring agent and water to form a mixture and by forming the mixture into granules.

3. The method as claimed in claim 1, wherein the step c) is conducted by compression molding.

4. The method as claimed in claim 2, wherein the granules are further processed by ball milling prior to step b).

5. The method as claimed in claim 2, further comprising a step of sieving the granules of each of the granular plastic materials prior to step b).

6. The method as claimed in claim 2, wherein the granules are dried at a temperature ranging from 80 to 120° C. prior to step b).

7. The method as claimed in claim 2, wherein the resin is melamine.
